(19) United States
(12) Patent Application Publication
(10) Pub. No.: US 2022/0048311 A1
(43) Pub. Date: Feb. 17, 2022

(54) SECURITY DOCUMENTS AND METHODS OF MANUFACTURE THEREOF

(71) Applicant: DE LA RUE INTERNATIONAL LIMITED, Basingstoke, Hampshire (GB)

(72) Inventor: John GODFREY, Basingstoke (GB)

(73) Assignee: DE LA RUE INTERNATIONAL LIMITED, Basingstoke, Hampshire (GB)

(21) Appl. No.: 17/413,261

(22) PCT Filed: Dec. 19, 2019
(86) PCT No.: PCT/GB2019/053625

§ 371 Date: Jun. 11, 2021

(30) Foreign Application Priority Data
Dec. 20, 2018 (GB) 1820842.1

(51) Int. Cl. B42D 25/47; B42D 25/351; B42D 25/22; B42D 25/342

(52) U.S. Cl. CPC B42D 25/47; B42D 25/342; B42D 25/22; B42D 25/351

(57) ABSTRACT

A security document and a method of forming a security document are disclosed. The method comprises: (a) providing a security document substrate having a security article integrated within or attached thereto, the security article being exposed within an aperture region in the security document substrate, the security article comprising a first optical effect layer that is visible within the aperture region, and; (b) applying, in said aperture region within which the security article is exposed, an array of substantially transparent refractive structures on the exposed security article, wherein the array of refractive structures cooperates with the first optical effect layer to exhibit a first optically variable effect.

### FIELD OF THE INVENTION

The present invention relates to methods of manufacturing security documents, and the corresponding products. Examples of such security documents include banknotes, cheques, passports, identify cards, certificates of authenticity, fiscal stamps and other secure documents, and typically include at least one security device that is may confirm their authenticity.

### BACKGROUND TO THE INVENTION

To prevent counterfeiting and to enable authenticity to be checked, security documents are typically provided with one or more security devices; by which we mean a feature that is not possible to reproduce accurately by taking a visible light copy, e.g. through the use of standardly available photocopying or scanning equipment.

Examples include features based on one or more patterns such as microtext, fine line patterns, latent images, venetian blind devices, lenticular devices, moiré interference devices and moiré magnification devices, each of which generates a secure visual effect. Other known security devices include holograms, watermarks, embossings, perforations and the use of colour-shifting or luminescent/fluorescent inks. Common to all such devices is that the visual effect exhibited by the device is extremely difficult, or impossible, to copy using available reproduction techniques such as photocopying. Security devices exhibiting non-visible effects such as magnetic materials may also be employed.

One class of security devices are those which produce an optically variable effect, meaning that the appearance of the device is different at different angles of view. Such devices are particularly effective since direct copies (e.g. photocopies) will not produce the optically variable effect and hence can be readily distinguished from genuine devices. Optically variable effects can be generated based on various different mechanisms, including holograms and other diffractive devices, colour-shifting materials, moiré interference and other mechanisms relying on parallax such as venetian blind devices, and also devices which make use of focusing elements such as lenses, including moiré magnifier devices, integral imaging devices and so-called lenticular devices.

To further increase the security level of secure documents, security devices may be visible only within a transparent window region or regions on one or more surfaces of the security document. In such cases, the security device is typically located on a security article that is incorporated within or attached to a security document substrate in such a manner that the device is visible within at least one window region. One example of a security article is a thread. Such a thread comprises at least one security device, and the thread is partially embedded within a security document substrate such that the security device(s) are visible in corresponding window regions(s).

A particular problem arises when the security devices comprise micro-optic structures which rely on refraction (e.g. lenses and microprisms). For the desired refractive mechanisms to take place, a sufficient difference in refractive index is required at the boundary of the micro-optic structure. As a result, it is difficult to adhere security articles having such micro-optic devices thereon within a security document substrate, since applying adhesive to the micro-optic structures reduces the refractive index change at the boundary of the structures, leading to a reduction in the refractive properties (“indexing-out”) of the structures. Furthermore, security articles having micro-optic structures are generally thicker than security articles not having such structures, which further increases the difficulty with which they may be incorporated into a document. Thus, typically, such micro-optic threads are only adhered into a security document on one side, which may lead to sub-optimal adhesion, and undesirable creasing of the document.

There is therefore a desire to provide security documents that overcome these problems.

### SUMMARY OF THE INVENTION

In accordance with a first aspect of the invention there is provided a method of forming a security document, the method comprising: (a) providing a security document substrate having a security article integrated within or attached thereto, the security article being exposed within an aperture region in the security document substrate, the security article comprising a first optical effect layer that is visible within the aperture region, and; (b) applying, in said aperture region within which the security article is exposed, an array of substantially transparent refractive structures on the exposed security article, wherein the array of refractive structures cooperates with the first optical effect layer to exhibit a first optically variable effect.

The security article is exposed within an aperture region in the security document substrate. The security article is “exposed” in that it is not covered by any further layer within the aperture region. The aperture region comprises an aperture in the security document substrate. The term “aperture” is used to mean a localised absence of security document substrate, and it is the lateral dimensions of the aperture that defines the aperture region. Preferably, the security article is exposed through the aperture of the aperture region, and step (b) comprises applying said array of refractive structures on the exposed security article through said aperture. The security article may also be said to be exposed within the aperture region if a part of the security article is exposed within the lateral extent of the aperture region.

An aperture region in the security document substrate is sometimes referred to as a type of window region. The lateral shape of the aperture may define substantially any geometrical shape such as a square, rectangle, circle, oval or more complex shape.

The aperture region in the security document substrate may be a partial thickness aperture region comprising a partial thickness aperture, in which the security article is exposed only on one side of the security document substrate; or a full thickness aperture region comprising a full thickness aperture, where the security article is exposed on both sides of the security document substrate. Thus, in the case of a full thickness aperture in the security document substrate, both sides of the security article may be said to be exposed within the aperture region.

Typically, the security article laterally extends substantially continuously across the aperture region. Moreover, typically, the security article is integrated within or attached to the security document substrate such that it laterally extends beyond, or “outside”, the aperture region. Typically the security article comprises a part(s) that is not exposed within the aperture region (e.g. a surface that is not visible on either side of the security document substrate), and at least one part that is exposed within the aperture region. The security article may therefore be referred to as at least partially exposed on at least one side of the security document substrate. The security article may be integrated within or attached to the security document substrate in such a manner that a surface of the security article is exposed both within the aperture region and outside the aperture region, for example in cases where the security document substrate comprises a full thickness aperture.

The present invention is particularly directed to applications where the security document substrate comprises a fibrous substrate, preferably a paper substrate. However, the invention is also directed to applications where the security document substrate comprises a polymer substrate such as biaxially-orientated polypropylene (BOPP) or polyethylene terephthalate (PET). Examples of security document which may be manufactured using the method of the present invention include banknotes, cheques, passports, identity cards, certificates of authenticity, fiscal stamps, visas or other documents for securing value or personal identity.

The security article that is integrated within or attached to the security document substrate is typically in the form of one of a security thread, strip, foil, insert, label or patch. The security article is integrated within or attached to the security document substrate in a conventional manner. One method for producing paper with a security article exposed within an aperture region can be found in EP-A-0059056. EP-A-0860298 and WO-A-03095188 describe different approaches for the embedding of wider threads into a paper substrate. Wide threads, typically having a width of 2 to 6 mm, are particularly useful as the additional exposed thread surface area allows for ease of application of the refractive elements in step (b).

The security article may be incorporated into a paper or polymer based substrate so that it is exposed on both sides of the finished security document substrate. Methods of incorporating security elements in such a manner are described in EP-A-1141480 and WO-A-03054297. In the method described in EP-A-1141480, one side of the security article is wholly exposed at one surface of the substrate in which it is partially embedded, and partially exposed in aperture regions at the other surface of the substrate.

The security article may also be applied to one side of a paper substrate so that portions are located in an aperture regions formed in the paper substrate. An example of a method of producing such an aperture can be found in WO-A-03054297. A further example of applying a security article to an aperture region formed in a paper substrate can be found in U.S. Pat. No. 6,428,051.

The present invention advantageously overcomes the problems outlined in the background section above by applying the array of substantially transparent refractive structures in a separate process to the initial provision of the security article within the security document substrate. The security article that is integrated within or attached to the security document substrate as provided in step (a) of the method is a security thread in its own right as it comprises an optical effect layer that is visible within the aperture region. Typically, the optical effect layer may be any layer that will cooperate with the refractive structures applied in step (b) to produce an optically variable effect. Preferred examples of such optical effect layers include a colour shifting layer and an array of microimage elements, as will be described in greater detail below.

In step (b) of the method, the refractive structures are applied on the exposed security article after the security article has already been incorporated within or attached to the security document substrate. Consequently, the problems of incorporating a “micro-optics”-based security article into a security document substrate that have been outlined above are overcome through the use of this two-step process. In particular, the security article of step (a) can be integrated within or attached to the security document substrate in an optical manner without the concerns of accommodating for the refractive structures. The refractive structures are then applied in step (b). In the finished security document, the first optical effect layer and the array of refractive structures define a security device, with the security device being positioned within the aperture region.

Typically, the array of refractive structures is applied in direct contact with the exposed security article within the aperture region. In some embodiments, the array of refractive structures may be formed on a separate support layer that is then applied on the exposed security article, as will be discussed further below. It will be appreciated that in the case of a support layer carrying the array being applied on the exposed security article, the array of refractive structures is still applied “on” the exposed security article. In other words, the term “on” may mean in direct contact with, or above.

The refractive structures are substantially transparent, here meaning that visible light is able to pass through.

Typically the security article comprises a security article substrate, and a first adhesive layer forming a first outer layer of the security article, wherein at least a part of said first adhesive layer is in contact with the security document substrate. The security article substrate is self-supporting and is typically substantially transparent to visible light although in alternative embodiments may be substantially opaque to visible light. Example materials for such a security article substrate include biaxially-orientated polypropylene (BOPP) or polyethylene terephthalate (PET). The thickness of the security article substrate is typically in the range of 5 to 60 microns, preferably 10 to 40 microns. The adhesive layer advantageously ensures that the security article is well adhered to the security document substrate. Adhesives that may be used are typically water-based. Examples of polymers that may be used are based on acrylates or methacrylates, vinyl acetates, EVA (ethelyne vinyl acetate), polyvinyl alcohol, styrene acetate, styrene acrylates and polyurethanes.

The refractive index of the adhesive layer is preferably substantially equal to that of the refractive structures that are applied in step (b). The adhesive layer is preferably substantially transparent to visible light with low haze (typically with 1-10%, preferably 1-5% of light passing through being diffused or scattered) such that the optical variable effect is clearly observed.

The first adhesive layer is typically applied and dried by evaporation, and then cured by the application of heat (typically between 70-120° C., preferably 80-100° C.) and/or pressure to cause polymerisation when the security article is adhered to the security article substrate.

In embodiments, at least a part of the first adhesive layer is exposed within said aperture region, and wherein step (b) comprises applying the array of substantially transparent microstructures on the exposed part of the first adhesive layer of the security article. Thus, counter-intuitively to conventional techniques, the array of refractive elements is formed on the adhesive layer such that in the finished security document, the first adhesive layer is positioned between the security article substrate and the array of refractive structures. Therefore, particularly advantageously, an adhesive layer may be used to adhere the security article to the security document substrate on the same side of the security article as the refractive structures. In other words, the refractive structures may be formed on the same adhesive layer that is used to adhere the security article to the security document substrate. This beneficially improves adhesion of the security thread to the security document substrate as compared to the conventional techniques of incorporating micro-optic security articles into security document substrates where conventional adhesives are difficult to use successfully on the same side of the security article as the refractive structures due to problems with the adhesive “indexing out” the refractive structures.

Typically, the first adhesive layer extends substantially continuously across a first surface of the security article substrate. Thus, a part of the first adhesive layer may be exposed within the aperture region of the security document substrate. The first adhesive layer may be in direct contact with the first surface of the security article substrate. Alternatively, the first adhesive layer may be above the first surface of the security article substrate (i.e. there may be a further layer positioned between the security article substrate and the first adhesive layer).

In embodiments, the first adhesive layer may be present substantially only in region(s) of the security article which are not exposed within the aperture region. For example, where the first adhesive layer is present on a side of the security article that is exposed through the aperture of the aperture region, the exposed part of the security article does not comprise adhesive and thus in step (b) the refractive structures are not applied on adhesive (for example they may be applied on the security article substrate). However, the security article is still advantageously adhered to the security document substrate on the side of the security article on which the refractive structures are applied.

In embodiments, the security article may be adhered to the security document substrate by said first adhesive layer, and wherein a second outer layer of the security article that opposes said first outer layer does not comprise adhesive. In other words, in such embodiments the security article comprises adhesive on only one side thereof. This is particularly advantageous in embodiments where the security article is adhered to one side of a security document substrate across a full aperture region in the security document substrate.

In such embodiments where the second outer layer of the security article does not comprise adhesive, step (b) of the method may comprise applying said array of substantially transparent refractive structures on said second outer layer. Here, although the array of refractive structures is not applied through the aperture that defines the aperture region, the array of refractive structures is still applied within the aperture region, i.e. within the lateral confines of the aperture region.

In embodiments, the security article comprises a second adhesive layer forming a second outer layer of the security article opposing said first outer layer, wherein at least a part of the second adhesive layer is in contact with the security document substrate. This is particularly preferred when the security article is integrated within the security document substrate so as to be exposed on one side of the security document substrate within a partial thickness aperture region. Thus, the security article is adhered to the security document substrate on both sides thereof, advantageously improving the adhesion of the security article within the security document substrate.

The second adhesive layer typically has the same properties as the first adhesive layer described above.

The second adhesive layer may extend substantially continuously across a second surface of the security article substrate, or may be present only in region(s) of the security article which are not exposed within the aperture region, in the same manner as discussed for the first adhesive layer.

In particularly preferred embodiments, the security article comprises first and second adhesive layers on opposing sides thereof for good adhesion to the security document substrate.

In embodiments, the array of refractive structures is arranged to cover the whole of the exposed part of the security article within the aperture region. In other embodiments, the array of refractive structures is arranged to cover a portion of the exposed part of the security article within the aperture region, wherein preferably the array of refractive structures is arranged in the form of indicia such as alphanumerical character(s), symbol(s), logo(s), graphics or the like.

In embodiments, the array of refractive structures may extend outside the aperture region, preferably wherein a region of the array that is outside the aperture region is on the security document substrate. This advantageously provides a security document that exhibits an optically variable effect within the aperture region, as well as a further visual effect outside the aperture region. The further visual effect may comprise a specular reflection effect that is visible at a particular viewing angle when light reflects off a surface of the refractive structures of the second array, for example. Furthermore, this advantageously reduces the registration tolerances required when applying the array of refractive structures on the exposed security article in step (b) of the method

Typically, the region of the array that is on the exposed security article comprises a first sub-array of refractive structures, and the region of the array that is on the security document substrate comprises a second sub-array of refractive structures. In embodiments, the refractive structures of the first and second sub-arrays are the same. However, in other embodiments the refractive structures of the first and second sub-arrays may be different. They may differ in geometry or dimension for example.

In embodiments, a region of the security document substrate outside the aperture region that is covered by the array of refractive structures comprises a second optical effect layer that cooperates with the corresponding region of the array to exhibit a second optically variable effect. The first and second optically variable effects typically differ, but in some embodiments may be substantially the same optically variable effect. The first and second optical effect layers may be the same or may differ from one another. For example, in some embodiments the first optical effect layer may comprise an image array and the second optical effect layer may comprise a colour shifting element.

In some embodiments, the array of refractive structures may extend substantially completely between two or more aperture regions in the security document substrate.

The first array of refractive microstructures in step (b) may be formed by cast-curing. Thus, in preferred embodiments, step (b) comprises: (i) applying a transparent curable material on the exposed security article or to a casting tool carrying a surface relief corresponding to the refractive structures, at least over an area corresponding to the exposed security article; (ii) forming the transparent curable material with the casting tool, and; (iii) curing the transparent curable material so as to retain the surface relief.

Advantageously, the transparent curable material is applied to the desired region (i.e. only the exposed security article within an aperture region, or to the exposed security article and a surrounding region of security document substrate) or to the casting tool only over the area corresponding to that of the desired region, and the casting tool carries the surface relief over an area extending beyond that of the desired region, preferably over substantially the whole area of the casting tool. In this way the lateral size and shape of the refractive structure array can be determined solely by the application of the curable material, with the surface relief being formed by a standard casting tool. This enables differently shaped refractive structure arrays to be formed using the same equipment through control of the application process only, making the method well adapted for the production of devices which are customised, e.g. to a particular series of banknotes, without having to produce a specific casting tool for the purpose. Preferably the casting tool comprises a cylinder carrying a sheet in which the surface relief is defined on its circumference.

Where the curable material is applied on the exposed security article, the curable material is typically applied so as to be in direct contact with the exposed security article.

In some embodiments, in step (b)(i) the transparent curable material is applied on the exposed security article and on a region of security document substrate outside the aperture region, preferably wherein the region of security document substrate outside the aperture region is laterally contiguous with said aperture region. Consequently, the formed array of refractive structures extends outside the aperture region such that a region of the array is on the security document substrate. Typically, the exposed security article within the aperture region and the security document surrounding said aperture region lie in different planes as a result of the aperture. Thus, in such embodiments, an excess of the transparent curable material is applied such that it “fills” the difference between the different planes, i.e. “fills” the aperture. The embossing process then aids to fill any remaining gaps and ensure that the refractive structures of the array lie in substantially the same plane.

As discussed above, advantageously the lateral size and shape of the refractive structure arrays can be determined solely by the application of the curable material, with the surface reliefs being formed by a standard casting tool. Thus, where the array comprises first and second sub-arrays having different refractive structures, these can be effected by appropriately registered regions of the surface relief on the casting tool.

In the above example of the method, the curable material was applied in direct contact with the exposed security article. In an alternative embodiment, the first array of refractive structures may be formed indirectly, for example on a separate support layer (e.g. by cast curing) that is then applied on the exposed security article, e.g. by lamination, adhesive or hot stamping, to affix the first array to the exposed security article. Alternatively, the support layer may act as a transfer element from which the formed refractive structure array may be applied to the exposed security substrate, leaving the support layer behind which may then be disposed of. In such embodiments, step (b) comprises: (i) applying a transparent curable material to a refractive structure support layer or to a casting tool carrying a surface relief corresponding to the refractive structures, at least over an area corresponding to the exposed security article; (ii) forming the transparent curable material with the casting tool, (iii) curing the transparent curable material so as to retain the surface relief, and; either applying the refractive structure support layer to the exposed security article, or applying the retained surface relief to the exposed security article and removing the refractive structure support layer.

The curable material is preferably radiation-curable and may comprise a resin which may typically be of one of two types, namely:

a) Free radical cure resins, which are typically unsaturated resins or monomers, pre-polymers, oligomers etc. containing vinyl or acrylate unsaturation for example and which cross-link through use of a photo initiator activated by the radiation source employed e.g. UV.

b) Cationic cure resins, in which ring opening (e.g. epoxy types) is effected using photo initiators or catalysts which generate ionic entities under the radiation source employed e.g. UV. The ring opening is followed by intermolecular cross-linking.

The radiation used to effect curing will typically be UV radiation but could comprise electron beam, visible, or even infra-red or higher wavelength radiation, depending upon the material, its absorbance and the process used. Examples of suitable curable materials include UV curable acrylic based clear embossing lacquers, or those based on other compounds such as nitro-cellulose. A suitable UV curable lacquer is the product UVF-203 from Kingfisher Ink Limited or photopolymer NOA61 available from Norland Products. Inc, New Jersey.

The curable material could itself also be elastomeric and therefore of increased flexibility. An example of a suitable elastomeric curable material is aliphatic urethane acrylate (with suitable cross-linking additive such as polyaziridine).

In embodiments, the first optical effect layer comprises a pattern of elements, preferably in the form of an image array. In such embodiments, the array of refractive structures is preferably an array of focusing elements, preferably lenses. In such cases, the optical spacing between the pattern of elements and the array of focusing elements is preferably substantially equal to the focal length of the focusing elements. As such, preferably the first optical effect layer (in the form of an image array) is located approximately in the focal plane of the focusing element array.

Typically, a transparent substrate of the security article acts as an optical spacer, with the first optical effect layer positioned on a distal side of the security article substrate with respect to the first array of refractive structures. In other embodiments, the first optical effect layer may be positioned on a side of the security article substrate proximal to the first array of refractive structures (in which case the security article substrate need not be transparent, and may be optically opaque to visible light). The casting tool discussed above may be configured such that the thickness of the formed transparent curable material is such that optical effect layer and the array of focusing elements are separated by the desired optical spacing.

In other embodiments, the method may further comprise the step of applying, in said aperture region, a substantially transparent pedestal layer, and wherein the array of substantially transparent refractive structures is applied on said pedestal layer. This is particularly advantageous in embodiments where the refractive structures are focusing elements as this allows the optical spacing between the focusing element array and first optical effect layer to be varied without the need to change the process for forming the focusing elements themselves. The use of a pedestal layer is particularly advantageous in embodiments where the array of focusing elements as applied on the second outer side of the security article substrate. In such embodiments, it will be appreciated that the refractive structures are still applied on the exposed security article in the aperture region.

In a particularly preferred embodiment, the at least one transparent material forming the pedestal layer is more flexible than the at least one transparent curable material used to form the refractive structures once cured. This acts as a buffer layer for absorbing deflections as may be experienced by the device during handling, e.g. bending, crumpling or the like. As such, damage to the refractive structures themselves is reduced. Advantageously, the at least one transparent material forming the pedestal layer is elastomeric. Preferably, the at least one transparent material forming the pedestal layer is a curable material having a lower concentration of cross-links than the at least one transparent curable used to form the refractive structures.

Examples of mechanisms that may provide the first optical effect in embodiments where the first optical effect layer comprises an image array and the refractive structures comprise focusing elements are set out below. It should be appreciated that in all aspects of the invention the focusing element array and image array could optionally be configured to provide any one or more of these effects, unless otherwise specified:

Moiré magnifier devices (examples of which are described in EP-A-1695121, WO-A-94/27254, WO-A-2011/107782 and WO2011/107783) make use of an array of focusing elements (such as lenses or mirrors) and a corresponding array of microimages, wherein the pitches of the focusing elements and the array of microimages and/or their relative locations are mismatched with the array of focusing elements such that a magnified version of the microimages is generated due to the moiré effect. Each microimage is a complete, miniature version of the image which is ultimately observed, and the array of focusing elements acts to select and magnify a small portion of each underlying microimage, which portions are combined by the human eye such that the whole, magnified image is visualised. This mechanism is sometimes referred to as “synthetic magnification”. The magnified array appears to move relative to the device upon tilting and can be configured to appear above or below the surface of the device itself. The degree of magnification depends, inter alia, on the degree of pitch mismatch and/or angular mismatch between the focusing element array and the microimage array.

Integral imaging devices are similar to moiré magnifier devices in that an array of microimages is provided under a corresponding array of lenses, each microimage being a miniature version of the image to be displayed. However here there is no mismatch between the lenses and the microimages. Instead a visual effect is created by arranging for each microimage to be a view of the same object but from a different viewpoint. When the device is tilted, different ones of the images are magnified by the lenses such that the impression of a three-dimensional image is given.

“Hybrid” devices also exist which combine features of moiré magnification devices with those of integral imaging devices. In a “pure” moiré magnification device, the microimages forming the array will generally be identical to one another. Likewise in a “pure” integral imaging device there will be no mismatch between the arrays, as described above. A “hybrid” moiré magnification/integral imaging device utilises an array of microimages which differ slightly from one another, showing different views of an object, as in an integral imaging device. However, as in a moiré magnification device there is a mismatch between the focusing element array and the microimage array, resulting in a synthetically magnified version of the microimage array, due to the moiré effect, the magnified microimages having a three-dimensional appearance. Since the visual effect is a result of the moiré effect, such hybrid devices are considered a subset of moiré magnification devices for the purposes of the present disclosure. In general, therefore, the microimages provided in a moiré magnification device should be substantially identical in the sense that they are either exactly the same as one another (pure moiré magnifiers) or show the same object/scene but from different viewpoints (hybrid devices).

Moiré magnifiers, integral imaging devices and hybrid devices can all be configured to operate in just one dimension (e.g. utilising cylindrical lenses) or in two dimensions (e.g. comprising a 2D array of spherical or aspherical lenses).

Lenticular devices on the other hand do not rely upon magnification, synthetic or otherwise. An array of focusing elements, typically cylindrical lenses, overlies a corresponding array of image sections, or “slices”, each of which depicts only a portion of an image which is to be displayed. Image slices from two or more different images are interleaved and, when viewed through the focusing elements, at each viewing angle, only selected image slices will be directed towards the viewer. In this way, different composite images can be viewed at different angles. However it should be appreciated that no magnification typically takes place and the resulting image which is observed will be of substantially the same size as that to which the underlying image slices are formed. Some examples of lenticular devices are described in U.S. Pat. No. 4,892,336, WO-A-2011/051669, WO-A-2011051670, WO-A-2012/027779 and U.S. Pat. No. 6,856,462. More recently, two-dimensional lenticular devices have also been developed and examples of these are disclosed in British patent application numbers 1313362.4 and 1313363.2. Lenticular devices have the advantage that different images can be displayed at different viewing angles, giving rise to the possibility of animation and other striking visual effects which are not possible using the moiré magnifier or integral imaging techniques.

Arrays of lenses or other focusing elements can also be used as a security device on their own (i.e. without a corresponding image array), since they can be used to exhibit a magnified or distorted view of any background they may be placed against, or scene viewed therethrough. This effect cannot be replicated by photocopying or similar.

Focusing elements that may be used in the present invention typically have a pitch in the range of 5-100 microns, preferably 20-60 microns; a height of 5-40 microns, preferably 5-20 microns and a focal length of 5-100 microns, preferably 5-75 microns.

It will be appreciated that the above techniques relating to focusing element mechanisms may be applied in embodiments where a region of the security document substrate outside the aperture region that is covered by the array of refractive structures comprises a second optical effect layer, and wherein the second optical effect layer comprises a pattern of elements, preferably in the form of an image array. In such cases, the dimensions of focusing elements formed above such a second optical effect layer are controlled such that the second optical effect layer lies approximately in the focal plane of said focusing elements.

In embodiments, the first optical effect layer comprises a colour shifting layer. Such a colour shifting layer generates a coloured appearance which changes dependent on viewing angle. Examples of known colour shifting structures include photonic crystals, liquid crystals, interference pigments, pearlescent pigments, structured interference materials or thin film interference structures including Bragg stacks. In the case where a colour shifting layer or structure comprises individual layers (for example an absorber layer, dielectric layer and reflector layer), for the purposes of this description, such a structure is referred to as a colour shifting layer. In such embodiments where the first optical effect layer comprises a colour shifting layer, the first array of refractive structures preferably comprises an array of microprisms. The angled facets of the microprisms refract the angle of light to and from the colour shifting layer in order such that the optically variable response in the region where microprisms are present is different to if they were not present. Examples of such techniques are described in documents WO2009/066048, WO2013/022699 and GB application number 1805055.9 (which describes additional specular reflection effects).

In embodiments, the array of microprisms may cover a portion of the exposed part of the security article within the aperture region, such that at a particular viewing angle, the portion covered by microprisms exhibits a first colour and the uncovered portion (where the first optical effect layer is still visible) exhibits a second, different colour. Where the portion covered by the array of microprisms is in the form of an indicium or indicia, this provides a striking effect to the viewer. In other examples, the array of microprisms may comprise regions having different orientations such that at different viewing angles the different regions exhibit different colours.

The microprisms are preferably symmetrical linear microprisms, but may have alternative forms such as asymmetrical microprisms, repeating faceted prisms or porro prisms. The array of microprisms typically has a pitch (e.g. the distance between adjacent elevations) in the range of 1-100 microns, preferably 5-70 microns, and a structure depth (e.g. the height of an elevation) in the range of 1-100 microns, more preferably 5-40 microns.

The colour shifting layer may be substantially opaque to visible light (for example an optically variable pigment), or at least partially transparent to visible light (for example a liquid crystal film), in which case it transmits at least some of the light that is incident upon it as well as providing an optical effect in reflection. Where an at least partially transparent colour shifting layer is used, it is preferable that the security article comprises an absorbing layer on a distal side of the colour shifting layer with respect to the array of refractive structures configured to absorb visible light in order that the effect in reflection dominates. Such an absorbing layer may be substantially transparent to UV-radiation to allow curing of the array of refractive structures therethrough. Such an absorbing layer may be the security article substrate itself, for example if the colour shifting layer is positioned on a side of the substrate proximal to the refractive structures.

Microprisms may be used in combination with an optical effect layer comprising an image array, and focusing elements may be used in combination with an optical effect layer comprising a colour shifting element in order to provide further effects. In general, the refractive structures may take substantially any form suitable to refract incident light, for example focusing elements and microprisms as discussed above, pyramidal structures and square-wave structures.

It will be appreciated that the above techniques relating to colour shifting layer and microprisms may be applied in embodiments where a region of the security document substrate outside the aperture region that is covered by the array of refractive structures comprises a second optical effect layer, and wherein the second optical effect layer comprises a colour shifting layer. In such cases, the dimensions of focusing elements formed above such a second optical effect layer are controlled such that the second optical effect layer lies approximately in the focal plane of said focusing elements.

In the above description, in step (a), a security document substrate is provided having a security article being exposed within an aperture region in the security document substrate. The security article may be exposed within a single aperture region, or may be exposed within a plurality of (i.e. two or more) aperture regions in the security document substrate (for example in the case of a “windowed thread”). Typically, an array of refractive structures will be formed on the exposed security article within each of the two or more aperture regions. However, in some embodiments, an array of refractive structures may be applied on the exposed security article in only some (i.e. not all) of the two or more apertures. The arrays of refractive structures are typically the same in each aperture region to which they are applied, but may differ from aperture region to aperture region. Thus, the security article may be exposed in a plurality of aperture regions in the security document substrate, and wherein step (b) comprises applying an array of refractive structures in at least one of said plurality of aperture regions.

The method of the present invention is preferably a performed as a sheet-based method, where in step (a) a plurality of such security document substrates, each having a security article integrated within or attached thereto, are provided on a sheet. Subsequent steps are performed using sheet-fed machinery. However, web-based implementations (where in step (a) a plurality of security document substrates are provided on a web) are also envisaged.

In accordance with a second aspect of the invention there is provided a security document comprising; a security document substrate having a security article integrated within or attached thereto, the security article being visible within an aperture region in the security document substrate, wherein the security article comprises; an optical effect layer that is visible within the aperture region, and a first adhesive layer forming a first outer layer of the security article, wherein the first adhesive layer is in contact with the security document substrate such that the security article is adhered to the security document substrate, and a part of the first adhesive layer laterally extends across the aperture region, wherein the security document further comprises; an array of substantially transparent refractive structures on the part of the first adhesive layer that laterally extends across the aperture region, wherein said array of refractive structures cooperates with the optical effect layer to exhibit an optically variable effect.

Thus, in a security document according to the second aspect of the invention, the array of refractive structures is formed on the adhesive layer that is used to adhere the security article to the security document substrate. Preferably, the array of microstructures is in direct contact with the first adhesive layer. However, in other embodiments, the security document may further comprise a support layer positioned between the array of refractive structures and the first adhesive layer. This may be the case in embodiments where the array of refractive structures is formed indirectly on a support layer (e.g. by cast curing) that is then applied on the exposed security article, e.g. by lamination, adhesive or hot stamping, to affix the first array to the exposed security article.

It is also envisaged that the security document may comprise a pedestal layer positioned between the array of refractive structures and the first adhesive layer. Such a pedestal layer provides the same advantages as discussed above.

In embodiments where the security document comprises a pedestal layer and/or support layer between the array of refractive structures and the first adhesive layer, the array of refractive structures is still referred to as “on” the first adhesive layer.

The security article may be visible within a plurality of aperture regions in the security document substrate, wherein parts of the first adhesive layer laterally extend across respective ones of the plurality of aperture regions, and wherein; the security document comprises at least one array of substantially transparent refractive structures on a respective part of the first adhesive layer that laterally extends across one of the aperture regions. Typically, the security document will comprise an array of refractive structures on the each of the parts of the first adhesive layer that extend across an aperture region. However, in some embodiments, the security document comprises an array of refractive structures on only some (i.e. not all) of the parts of the first adhesive layer that laterally extend across an aperture region. Where the security document comprises more than one array of refractive structures, these are preferably substantially the same, although in alternative embodiments may differ from one another.

Preferred features of the second aspect of the invention are set out in the appended claims, and provide the same benefits as described above with reference to the first aspect.

Also disclosed herein is a security document made in accordance with the first aspect of the invention.

Also disclosed herein is a series of security documents, each made in accordance with the first aspect, or each in accordance with the second aspect.

### BRIEF DESCRIPTION OF THE DRAWINGS

Preferred examples of the invention will now be described with reference to the attached drawings, in which:

FIG. 1 is a flow diagram outlining the steps of a preferred method of manufacturing a security document, according to the present invention;

FIG. 2 schematically illustrates a first example embodiment of manufacturing a security document according to the invention;

FIG. 3 schematically illustrates a second example embodiment of manufacturing a security document according to the invention;

FIGS. 4 and 5 schematically depict two preferred cast-curing techniques which may be used in the method of the present invention;

FIGS. 6 to 13 schematically illustrate further example embodiments of manufacturing a security document according to the invention, and;

FIGS. 14 and 15 illustrate comparative examples.

### DETAILED DESCRIPTION

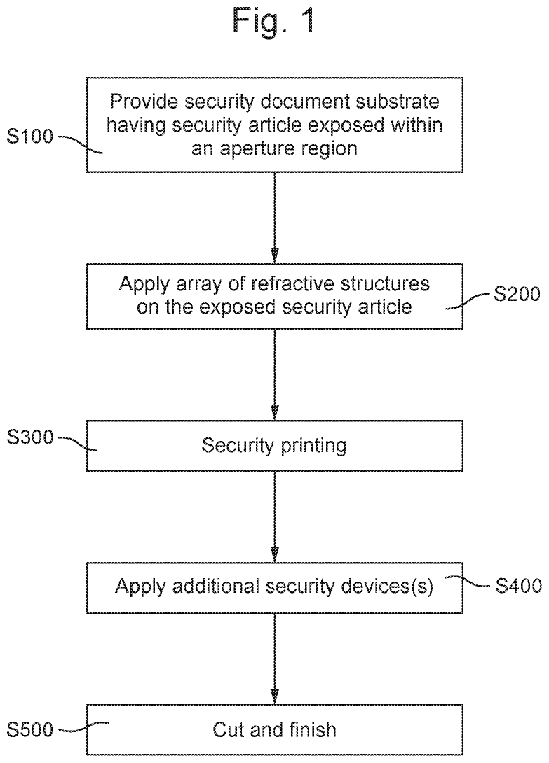

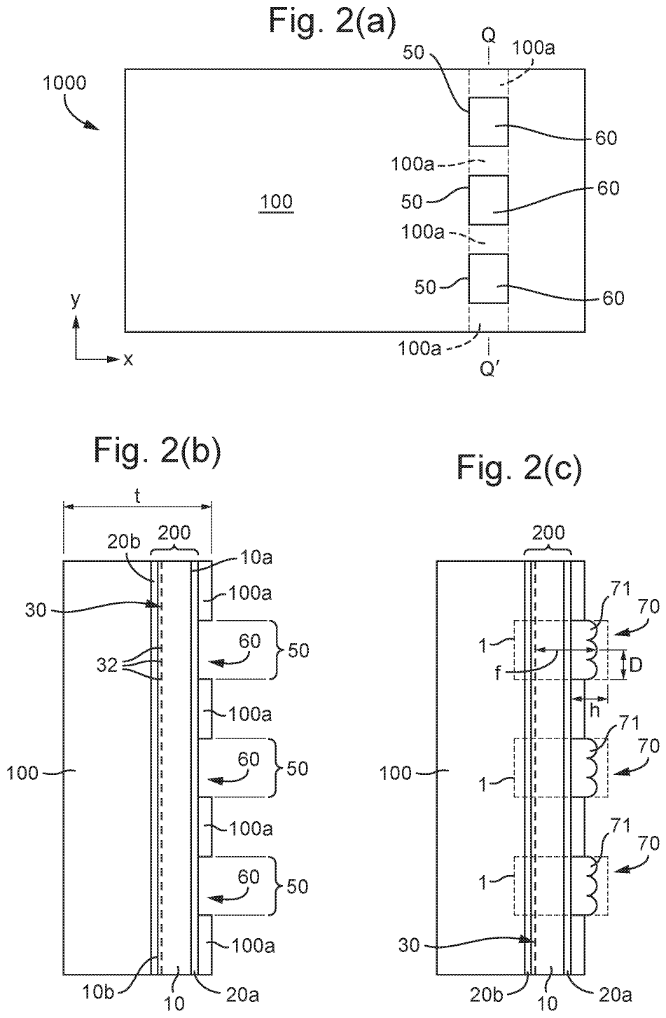

FIG. 1 is a flow diagram outlining the steps of a method of manufacturing a security document according to the present invention, and will be described in more detail with reference to FIGS. 2 to 13. In the following, any of the features of the described embodiments may be used in combination with the other embodiments.

In step S100, a security document substrate is provided having a security article exposed within an aperture region of the security document substrate. The security article is integrated within or attached to the security document substrate using standard techniques, as have been discussed in the summary of the invention section above. In particular, such security articles may be applied to or incorporated into documents of value such as banknotes, passports, driving licences, cheques, identification cards etc.

The method of FIG. 1 is preferably a sheet-based method. In other words, at step 100, a plurality of security document substrates, each having a security article integrated within or attached thereto, are provided as a sheet of material and arranged in an m×n array. This may involve sheeting an initial web of such security document substrates into a plurality of sheets. The subsequent steps of the method are performed using sheet-fed machinery. However, the following examples will be described with reference to individual security documents for ease of description, without limitation. Although a sheet-based implementation is preferred, in other applications of the present invention, the method may be a web-based method, at least for steps S100 and S200.

FIG. 2 schematically illustrates a first example of manufacturing a security document according to the invention. FIGS. 2(a) and 2(b) illustrate a security document substrate 100, here in the form of a paper substrate for a banknote 1000. FIG. 2(a) shows the banknote 1000 in plan view and FIG. 2b as a cross-section along line Q-Q′. Typical thicknesses, t, of the banknote are between 50 and 200 microns, preferably between 70 and 150 microns.

In this example the security article 200 is in the form of a security thread, which is inserted during paper-making such that it is partially embedded into the paper so that portions of the paper 100 lie on either side of the thread. The security thread is exposed within a plurality of aperture regions 50. This can be done using the techniques described in EP0059056 where paper is not formed in the aperture regions 50 during the paper making process, thus exposing the security thread within the aperture regions 50 through apertures 60 in the paper substrate. Alternatively the aperture regions 50 may for example be formed by abrading the surface of the paper in these regions after insertion of the thread. The security thread 200 is exposed through the apertures 60 on one surface of the banknote, and hence the apertures are “half-thickness” apertures. The aperture regions 50 are defined by the lateral shape of the apertures 60

The thread 200 comprises a transparent polymer substrate 10 having opposing first and second surfaces 10a and 10b, and the thread extends continuously along the full height of the banknote. The thread 200 further comprises an optical effect layer 30 on the second surface 10b of the thread substrate, i.e. distal to the surface of the thread that is exposed through the apertures 60. The thread is adhered into the paper substrate using transparent adhesive layers 20a, 20b on both sides of the thread 200.

In this example the optical effect layer 30 comprises an array of microimage elements schematically illustrated at 32, which are formed on surface 10b of the thread substrate 10. The optical effect layer is visible within each aperture region 50 through the apertures 60 due to the transparent properties of the thread substrate 10 and the adhesive layer 20a. In this example, the array of microimage elements extends continuously along the surface 10b of the thread substrate, but in alternative embodiments the optical effect layer may be provided only on regions of surface 10b that are in register with the apertures 60.

The array of microimage elements 30 may be provided using conventional printing techniques such as lithographic printing, fleoxographic printing or gravure, with line widths typically between 5-50 microns. One method which may be used as an alternative to the printing techniques mentioned above is used in the so-called Unison Motion™ product by Nanoventions Holdings LLC, as mentioned for example in WO-A-2005052650. This involves creating pattern elements (“icon elements”) as recesses in a substrate surface before spreading ink over the surface and then scraping off excess ink with a doctor blade. The resulting inked recesses can be produced with line widths of the order of 2 microns to 3 microns.

A different method of producing high-resolution image elements is disclosed in WO-A-2015/044671 and is based on flexographic printing techniques. A curable material is placed on raised portions of a die form only, and brought into contact with a support layer preferably over an extended distance. The material is cured either whilst the die form and support layer remain in contact and/or after separation. This process has been found to be capable of achieving high resolution and is therefore advantageous for use in forming the microimage array 30 in the present application.

Some more particularly preferred methods for generating patterns or micropatterns (i.e. a microimage array 30) on a substrate are known from US 2009/0297805 A1 and WO 2011/102800 A1. These disclose methods of forming micropatterns in which a die form or matrix is provided whose surface comprises a plurality of recesses. The recesses are filled with a curable material, a treated substrate layer is made to cover the recesses of the matrix, the material is cured to fix it to the treated surface of the substrate layer, and the material is removed from the recesses by separating the substrate layer from the matrix.

Another method of forming a micropattern is disclosed in WO 2014/070079 A1. Here it is taught that a matrix is provided whose surface comprises a plurality of recesses, the recesses are filled with a curable material, and a curable pickup layer is made to cover the recesses of the matrix. The curable pickup layer and the curable material are cured, fixing them together, and the pickup later is separated from the matrix, removing the material from the recesses. The pickup layer is, at some point during or after this process, transferred onto a substrate layer so that the pattern is provided on the substrate layer.

Referring back to FIG. 2, the first adhesive layer 20a extends continuously across the first surface 10a of the thread substrate such that it not only adheres the thread 200 to the paper “bridges” 100a between the apertures, but is also exposed within aperture regions 50 through the apertures 60 themselves. Thus, in this example the surface of the thread 200 that is exposed through the apertures 60 comprises the first adhesive layer 20a.

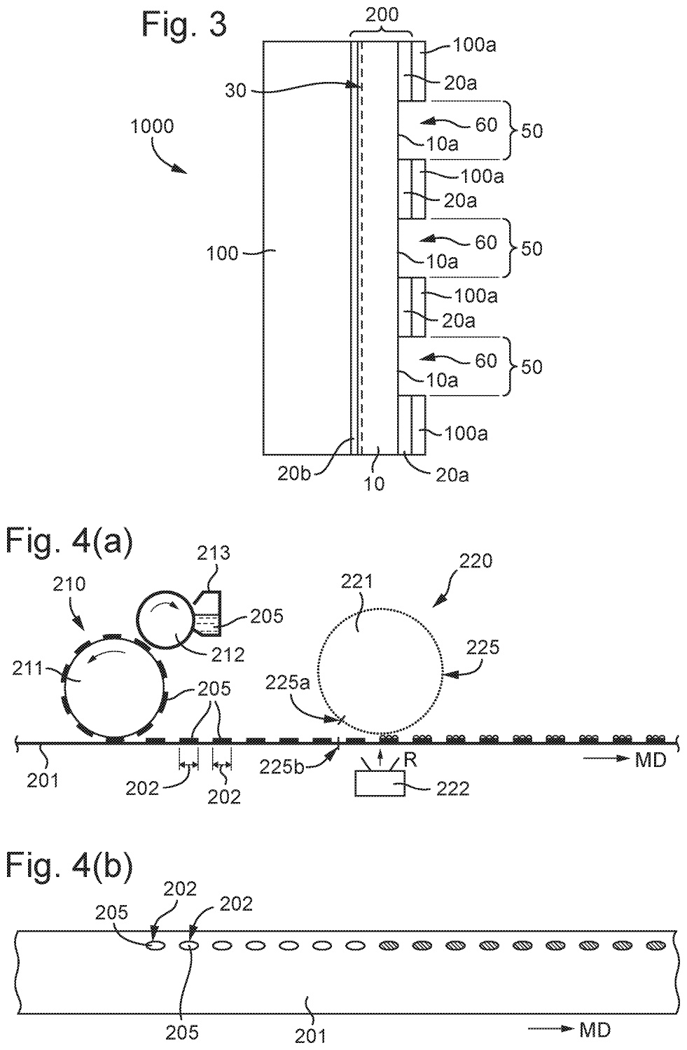

In an alternative embodiment (schematically illustrated in FIG. 3), the adhesive of the first adhesive layer 20a is provided in register with the paper bridges 100a such that no adhesive is exposed within the aperture regions 50 through the apertures 60. The adhesive layer 20a may there be seen as a partial layer comprising gaps registered with the aperture regions such that the adhesive is provided in register with the paper bridges 100a. In this example, the surface of the thread 200 that is exposed through the apertures 60 is the first surface 10a of the thread substrate 10.

At step S200 of the method, an array 70 of focusing elements in the form of microlenses 71 is applied to the exposed security in each aperture region, as schematically shown in FIG. 2(c). The lenses are formed by cast curing a curable material as will be explained in more detail below. As will be appreciated, in the example of FIG. 2(c), the focusing elements are formed directly onto the first adhesive layer 20a which is exposed through the apertures 60. In the embodiment shown in FIG. 3, the focusing elements will be formed directly onto the first surface 10a of the transparent thread substrate 10. The microlenses 71 cooperate with the microimage elements 32 to exhibit an optically variable effect to an observer of the banknote 1000 using any of the mechanisms that have been discussed in the summary of the invention (e.g. moiré magnification, lenticular effects etc.).

The resulting security document thus comprises security devices 1 defined by the optical effect layer and corresponding arrays of refractive structures, as illustrated in FIG. 2(c).

The focusing elements have a focal length f that is substantially equal to the optical spacing between the lenses and the microimage array 30, such that the focal plane of the arrays 70 substantially corresponds to the plane of the microimage array (i.e. the second surface 10b of the security thread). In other words, the combined thickness of the curable material, adhesive layer 20a and transparent substrate 10 is substantially equal to the focal length of the focusing elements. The thickness, h, of the curable material in which the lenses are formed is controlled in the casting process such that the correct optical spacing is achieved.

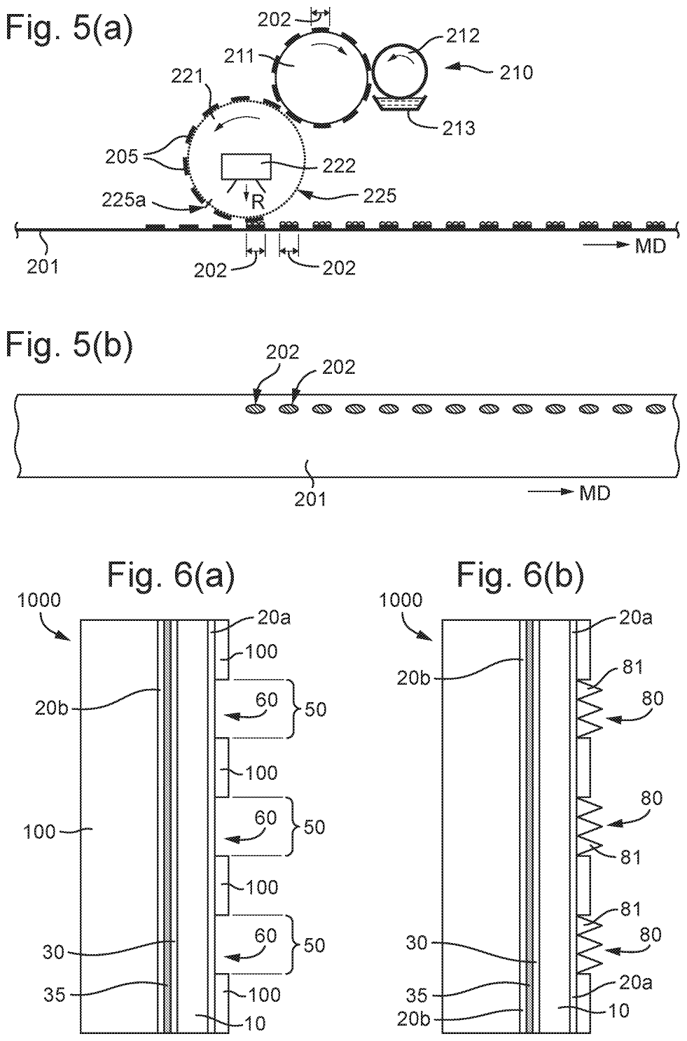

The most preferred method of forming the focusing element arrays 70 is by cast-curing. This involves applying a transparent curable material to the exposed security thread or to a casting tool carrying a surface relief defining the desired focusing element array, forming the material using the casting tool and curing the material to fix the relief structure into the surface of the material. FIGS. 4 and 5 schematically depict two preferred cast-curing techniques which may be used. Components common to both methods are labelled with the same reference numbers. In both cases the process is shown as applied to a support layer 201 which may be the aforementioned exposed security article 200, or could be a separate support layer which is later applied to the exposed security article 200 (e.g. a transfer foil that may be applied to the exposed security article by a foiling machine). In each case, Figure (a) depicts the apparatus from a side view, and Figure (b) shows the support layer in a perspective view, the manufacturing apparatus itself being removed for clarity.

In the FIG. 4 embodiment, a transparent curable material 205 is first applied to the support layer 201 using an application module 210 which here comprises a patterned print cylinder 211 which is supplied with the curable material from a doctor chamber 213 via an intermediate roller 212. For example, the components shown could form part of a gravure printing system. Other printing techniques such as lithographic, flexographic, screen printing or offset printing could also be used. Print processes such as these are preferred since the curable material 205 can then be laid down on the support 201 only in first regions 202 thereof, the size, shape and location of which can be selected to conform to the apertures by control of the print process, e.g. through appropriate configuration of the pattern on cylinder 211. However, in other cases, an all over coating method could be used, e.g. if the focusing element array is to be formed all over the support 201. The curable material 205 is applied to the support 201 in an uncured (or at least not fully cured) state and therefore may be fluid or a formable solid.

The support 201 is then conveyed along the machine direction or sheet path MD to a casting module 220 which here comprises a casting tool 221 in the form of a cylinder carrying a surface relief 225 defining the shape of the focusing elements which are to be cast into the curable material 205. The surface relief 225 may be formed in the cylinder surface itself, or on a plate mounted to the cylinder. As each region 202 of curable material 205 comes into contact with the cylinder 221, the curable material 205 fills a corresponding region of the relief structure, forming the surface of the curable material into the shape defined by the relief. The cylinder 221 could be configured such that the relief structure 225 is only provided at regions corresponding to shape and position of the first regions 202 of curable material 205. However this gives rise to the need for accurate registration between the application module 210 and the casting module 220 in order that the focusing elements are accurately placed in each first region 202 of the curable material. Therefore in a particularly preferred embodiment, the cylinder 221 carries the relief structure corresponding to the focusing elements over an area larger than that of the first region 202, preferably around its complete circumference and most preferably over substantially its whole surface (although axial regions which will not come into the vicinity of the curable material may be excluded). In this way, each entire first region 202 of curable material 205 is guaranteed to come into contact with the surface relief structure 225 such that the focusing element array is formed over the full extent of the material. As a result, the shape, size and location of the focusing element array 20 is determined solely by the application of the curable material by the application module.

Having been formed into the correct surface relief structure, the curable material 205 is cured by exposing it to appropriate curing energy such as radiation R (typically UV radiation) from a source 222. This preferably takes place while the curable material is in contact with the surface relief 225 although if the material is already sufficiently viscous this could be performed after separation. In the example shown, the material is irradiated through the support layer 201 (typically the case when the lenses are formed on a transfer foil) although the source 222 could alternatively be positioned above the support layer 201, e.g. inside cylinder 221 if the cylinder is formed from a suitable transparent material such as quartz.

In one embodiment the curable material 205 is partially cured while in contact with the surface relief 225, with a subsequent cure performed after the curable material is released from the surface relief to fully cure the curable material. The radiation applied to cure the material after it is released from the surface relief may be directed through the support layer 201, or from above the support layer.

In a variation to the process shown in FIG. 4, the print cylinder 211 may be a screen print unit 211 carrying a screen corresponding to the first regions, where the curable material 205 is pushed from the inside of the roller 211 out of the screen by a squeegee directly on to the support 201.

FIG. 5 shows a further variant of the above process in which, rather than apply the curable material 205 to the support layer 201, it is applied instead to the surface of the casting cylinder 225. Again this is preferably done in a patterned manner, using a print cylinder 211 to transfer the curable material 205 only onto the first regions 202 on the casting cylinder 221. Upon contact with the support layer 201, the regions 202 of curable material 205 affix to the support layer 205 and curing preferably takes place at this stage to ensure strong bonding. The so-formed focusing element arrays 70 again have a shape, size and location determined solely by the application module 210.

In both the processes illustrated in FIGS. 4 and 5, a counter impression cylinder (not shown) may be used on the opposing side of the support layer 201 to the casting cylinder 221.

In FIGS. 4 and 5, the surface relief of the casting cylinder 225 defines the arrays of focusing elements seen in FIG. 2(c). However, it will be appreciated that the surface relief may take substantially any form so as to form a variety of refractive structures in the curable material 205, and thus the cast methods described above in relation to FIGS. 4 and 5 may be used in any of the herein-described embodiments. Examples of different refractive structures will be described herein.

The transparent curable material 205 in which the lenses are formed can be of various different compositions as discussed in the summary of the invention section.

Other examples of security document substrates and the application of refractive structures will now be described.

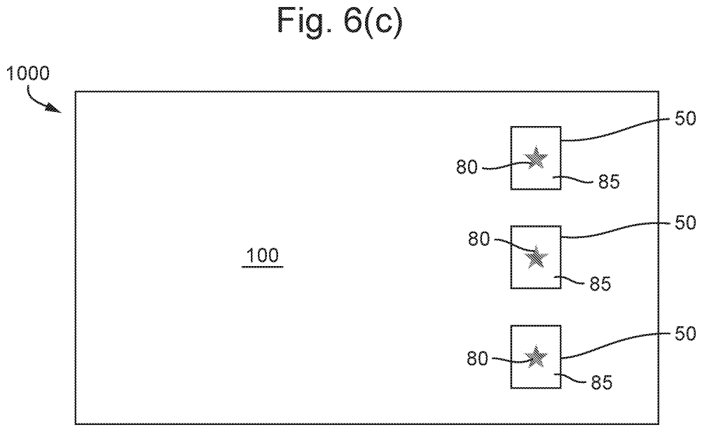

FIG. 6(a) is a cross sectional view of a security document substrate 1000 for a banknote similar to FIG. 2(b). As with FIG. 2(b), the security thread 200 is partially embedded within paper substrate 100 and exposed within aperture regions 50 through apertures 60 in the security document substrate 100 such that the optical effect layer 30 is visible through the apertures. In this example, the optical effect layer comprises a colour shifting layer that exhibits different colours at different tilt angles. In this example the colour shifting layer is a partially transparent liquid crystal film that is formed on the second surface 10b of the thread substrate 10. The liquid crystal film is partially transparent and thus an absorbing layer 35 is provided on a side of the liquid crystal film distal to the exposed surface of the thread. Here the light absorbing layer acts to absorb light in the visible part of the electromagnetic spectrum (approximately 400 to 750 nm), and is preferably substantially transparent to UV radiation such that the curing process described above in FIGS. 4 and 5 may be easily implemented. The thread is adhered into the paper substrate 100 using adhesive layers 20a and 20b.

At step S200, an array 80 of linear microprisms 81 is applied to the exposed security article in each aperture region, as illustrated at FIG. 6(b). The linear microprisms cooperate with the colour shifting layer to change the colour response upon tilting as compared to if no prisms were present.

In the example shown in FIG. 6(b), the linear microprisms are cast such that their long axes are aligned with the width of the banknote (i.e. along the x-axis in FIG. 2(a)). This provides the strongest optically variable effect when the banknote 1000 is tilted about a tilt axis parallel with the x-axis (i.e. about an axis parallel with the long axes of the microprisms). It will be appreciated that the microprisms may be applied in other orientations, for example with their long axes aligned with the height of the banknote (along the y-axis). Furthermore, each array of microprisms may comprise regions (or “sub-arrays”) of microprisms having different orientations and/or geometry. This provides a particularly striking visual effect as each aperture region of the banknote may exhibit different colours (corresponding to the different orientations of microprisms) at a particular viewing angle (i.e. tilt angle).

The arrays of linear microprisms may be applied on the exposed security thread so as to only partially cover the exposed security thread within each aperture region 50. For example, each array may be in the form of indicia, as illustrated in FIG. 6(c) where the arrays are applied in the form of a star shape. When viewing the security document, at a particular viewing angle, the star shape and the surrounding region 85 where the liquid crystal layer is visible in isolation (i.e. not through the micoprisms) will appear in different colours, providing a striking effect to the user. In some embodiments, the arrays of refractive structures may be applied having different forms in each aperture region 50 so as to exhibit different indicia.

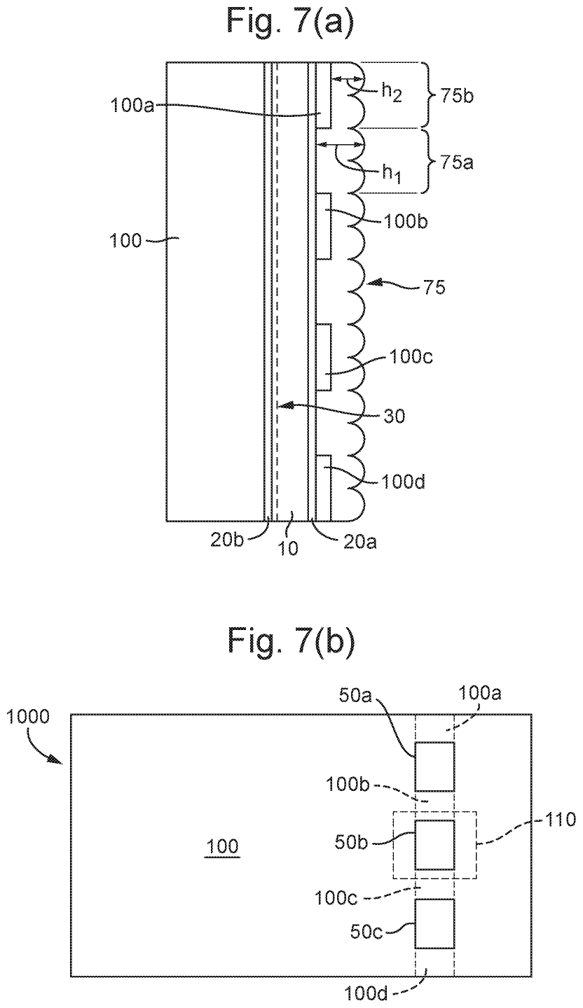

FIG. 7 illustrates a further example of manufacturing a security document according to the invention, where the array of refractive structures 75 that is applied in step S200 also extends across regions of the security document substrate outside the aperture regions 50. In step S100, a security document substrate and security article are provided as described above in relation to FIGS. 2(a) and 2(b). In step S200, the transparent curable material is applied to both the exposed security article within each aperture region 50, and also to the paper substrate between each aperture region.

The curable material 205 is initially applied such that it “fills” the apertures 60 of the apertures regions and extends over the paper substrate outside the aperture regions. This ensures that the refractive structures (in this case microlenses) are located on substantially the same plane within the finished security document after embossing. Applying the curable material in this manner so as to extend outside the aperture regions reduces the registration tolerances required when embossing the refractive structures. The curable material within the aperture regions 50 (shown at 75a) has a height, h1, that is greater than the height h2 of the curable material on the paper substrate outside of the apertures (shown at 75b). Accordingly, the dimensions of the cast microlenses at least in the aperture regions will be such that their focal length is substantially equal to the combined thickness of the thread substrate 10, adhesive layer 20a and curable material 205.

The resulting security document exhibits a particularly striking effect in that an observer will perceive the above-described optically variable effect within the aperture regions 50 due to the refractive properties of the microlenses, as well as a bright “flash” at certain viewing angles due to specular reflection off the lenses that are positioned on the paper bridge regions. This specular reflection effect is more pronounced in embodiments where the refractive structures that are cast in step S200 have planar facets (e.g. linear microprisms).

In the embodiment illustrated in FIGS. 7(a) and 7(b), the curable material 205 is applied substantially continuously over each bridge region 100a, 100b, 100c and 100d, and within the apertures of each aperture region 50a, 50b, 50c (see FIG. 7(b)) such that the resulting microlens array 75 extends substantially continuously between each aperture region over the full height of the banknote. Here, the microlens array 75 has substantially the same lateral width as the aperture regions 50, but may have a lateral width that is different to that of the aperture regions. However, in other embodiments, the curable material 205 (and consequently the microlens array 75) may be applied so as to extend only partially over the bridge regions, or only between certain aperture regions. Furthermore, the curable material 205 may be applied so as to surround the complete circumference of an aperture region, as schematically illustrated at 110 in FIG. 7(b).

In general, in such an embodiment the region(s) of the security document substrate outside the aperture regions on which the curable material is applied is substantially laterally contiguous with an aperture region.

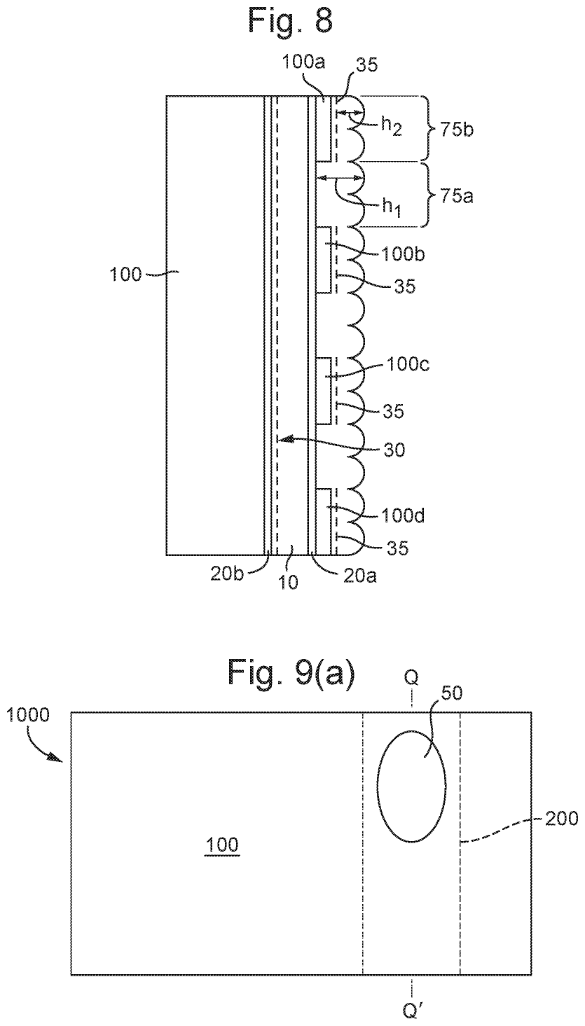

FIG. 8 schematically illustrates an example in which the paper bridges 100a, 100b, 100c, 100d have thereon a second optical effect layer 35 in the form of an array of microimage elements. Here, the microlenses of the array that are formed over the bridge regions (schematically represented at 75b) cooperate with the array of microimage elements 35 in order to exhibit an optically variable effect, which may be for example a lenticular- or moiré-based effect in the same manner as described for the aperture regions.

Here, the thickness h2 of the curable material outside the aperture regions is substantially equal to the focal length of the microlenses outside the aperture regions. Consequently, the microlenses that are formed laterally outside the aperture regions have different dimensions (typically height) to those formed laterally within the aperture regions. The surface relief of the casting tool therefore comprises regions corresponding to the regions of the array 75a that are applied within the aperture regions, and to regions of the array 75b laterally outside of the aperture regions.

In other embodiments, the second optical effect layer 35 may comprise a colour shifting layer, with the refractive structures that are formed outside of the aperture regions and over the colour shifting layer comprising microprisms. In such embodiments preferably the whole array 75 comprises microprisms and the first optical effect layer 30 comprises a colour shifting layer.

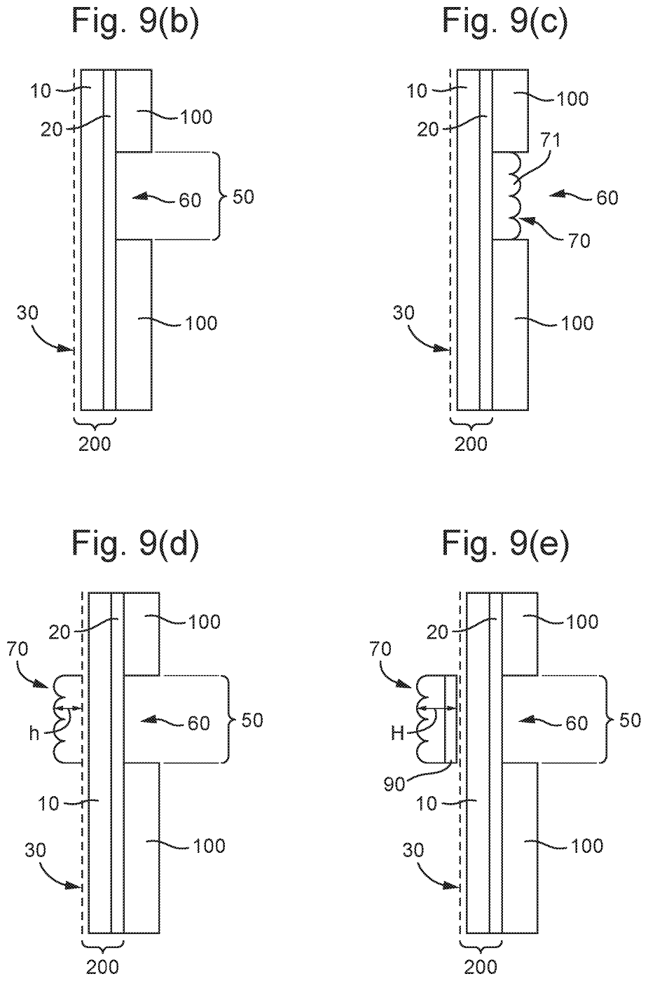

FIG. 9 illustrates a yet further example of a method of manufacturing a security document according to the present invention. Here, the structure provided in step S100 is illustrated in FIGS. 9(a) and 9(b), and is again a paper banknote 1000, where FIG. 9(a) is a view of the front side of the banknote, and FIG. 9(b) is a cross section along line Q-Q′. Security article 200 is a strip or band comprising a transparent substrate 10 and an optical effect layer 30, which in this example comprises an array of microimage elements.

The security article 200 is formed into a security document 1000 comprising a fibrous substrate 100, using a method described in EP-A-1141480. The paper substrate 100 comprises a full thickness aperture 60 defining aperture region 50. The aperture may be formed during papermaking or after papermaking, for example by die-cutting or laser cutting. The strip 200 is adhered on to one side of the paper 100 across the aperture 60 using adhesive layer 20 such that it extends across the aperture 60 and is exposed through the aperture 60 within aperture region 50.

As can be seen in FIG. 9(b), the strip 200 is fully exposed on one side of the document and exposed through the aperture 60 on the opposite side of the document (FIG. 9(a)). There is no adhesive on the surface of the strip that is distal to the paper substrate 100.

In step S200, and as shown in FIG. 9(c), an array 70 of microlenses 71 is formed on the adhesive layer 20 that is exposed within aperture region 50 through the aperture 60, using any of the techniques discussed above, wherein the array of microlenses cooperates with the array of microimage elements 30 to exhibit an optically variable effect. In an alternative arrangement, similarly to FIG. 3, the adhesive layer 20 may be omitted across aperture region 50 such that the array 70 of focusing elements as applied directly to the security article substrate 10.

FIG. 9(d) illustrates a further embodiment where the array 70 of microlenses is applied on the side of the security article 200 that is fully exposed, i.e, the side of the security article that is distal to the aperture 60 itself. In this embodiment, the array 70 is applied laterally within the aperture region 50, as shown in FIG. 9(d). The thickness, h, of the curable material 205 that is used to form the array of microlenses is controlled such that its thickness is substantially equal to the focal length of the microlenses. In an alternative embodiment, as shown in FIG. 9(e), a transparent pedestal layer 90 may be applied between the security article 200 and the curable material in which the array of microlenses is defined. The combined thickness, H, of the pedestal layer 90 and the curable material in which the array of microlenses is defined is substantially equal to the focal length of the lenses since here the microimage array 30 is on the same side of the security article as the array of microlenses. In variations to FIGS. 9(d) and 9(e), the optical effect layer may be provided on the opposing side of the security article substrate (i.e. proximal to the aperture 60) such that the optical spacing between the lenses and microimage array includes the transparent security article substrate 10.

Such a pedestal layer 90 may be applied prior to the application of the array of microlenses by applying a transparent material to the security article or to a separate support layer that is subsequently affixed to the security article. This could involve printing or coating the pedestal material onto the security article or separate support layer using any of the methods described above for the application of the curable material 205, for example gravure printing. The pedestal material is preferably applied in a selective manner to at least the desired region within which the array of microlenses is to be formed. In the example illustrated in FIG. 9(e), the regions in which the pedestal layer 90 and array 70 of microlenses are applied are substantially the same, but this is not essential, and indeed may not be desirable as this gives rise to greater registration requirements. It will be appreciated that such a pedestal layer 90 may be used in combination with other refractive structures, such as microprisms.

In both FIGS. 9(d) and 9(e), the array 70 of microlenses is applied on the exposed security article laterally within the aperture region 50. However, in further embodiments (not shown), the array may extend outside the aperture region.

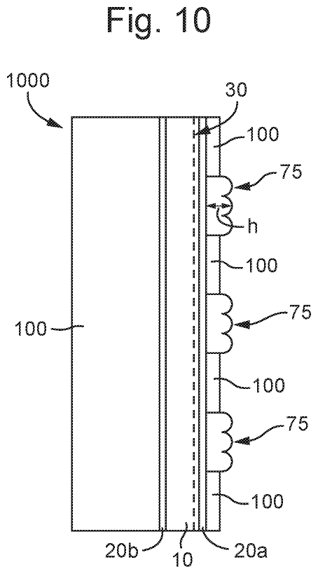

In the embodiments that have been described so far, the optical effect layer 30 has been positioned on a side of the security article substrate that is distal from aperture(s) in the security document substrate 100. Hence, the security article substrate is substantially transparent such that the optical effect layer is visible within the aperture regions(s) through the aperture(s) 60. However, in any of the embodiments described herein, the optical effect layer 30 may be positioned on a side of the security article substrate that is proximal to aperture(s) in the security document substrate, as schematically illustrated in FIG. 10. The optical effect layer may be applied to the first surface 10a of the security article substrate, for example.

Here, the optical effect layer is in the form of an array of microimage elements, with the refractive structures formed as microlenses. The thickness, h, of the curable material used to form the microlenses is controlled appropriately such that the optical spacing between the lenses and the microimage elements is approximately equal to the focal length of the lenses. A pedestal layer (not shown) may also be used to control the optical spacing.

Furthermore, in such embodiments where the optical effect layer is provided on a side of the security article proximal to the cast refractive structures, the security article substrate need not be transparent, and may be substantially opaque to visible light. This may be particularly advantageous where the optical effect layer comprises a substantially transparent colour shifting layer, as the security article substrate may act as a light absorbing layer. Such a substrate would preferably be transparent to UV radiation for ease of implementation of the cast curing process.

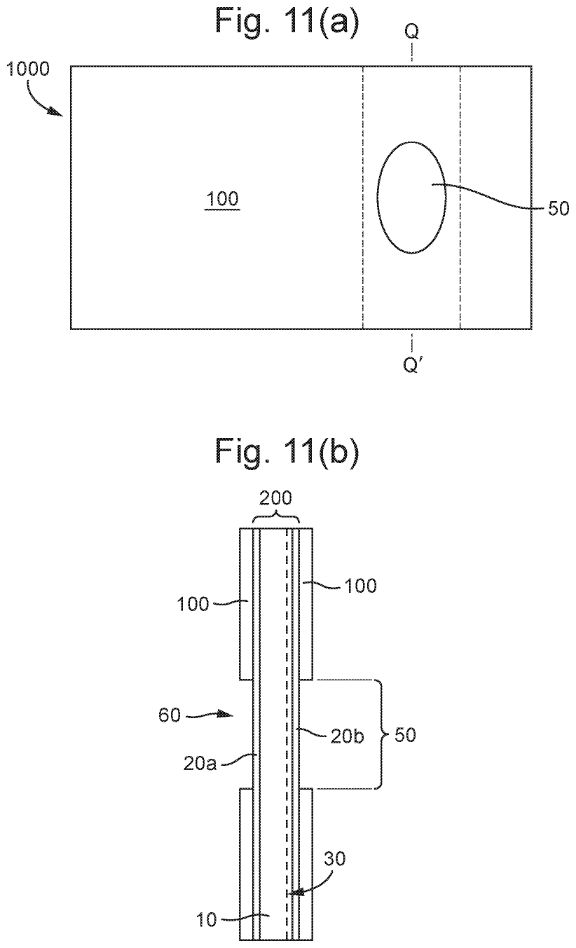

FIGS. 11(a) and 11(b) illustrate a further example structure that may be provided in step S100, again in the form of a banknote 1000. In FIG. 11(a) the banknote 1000 is a conventional paper-based banknote, provided with a strip element or insert as the security article 200. The strip 200 is exposed through full thickness aperture 60 formed in the paper substrate 100, with said aperture 60 defining aperture region 50. In this example, an array of refractive structures may be applied to the exposed strip on the front surface of the banknote (here, on the adhesive layer 20a within aperture region 50) that cooperates with optical effect layer 30 in order to provide an optically variable effect when viewed from that side of the document. It is also envisaged that a second array of refractive structures may be applied to the opposing exposed surface of the strip (i.e. on adhesive layer 20b) such that an optically variable effect is exhibited when the banknote 1000 is viewed from both sides.

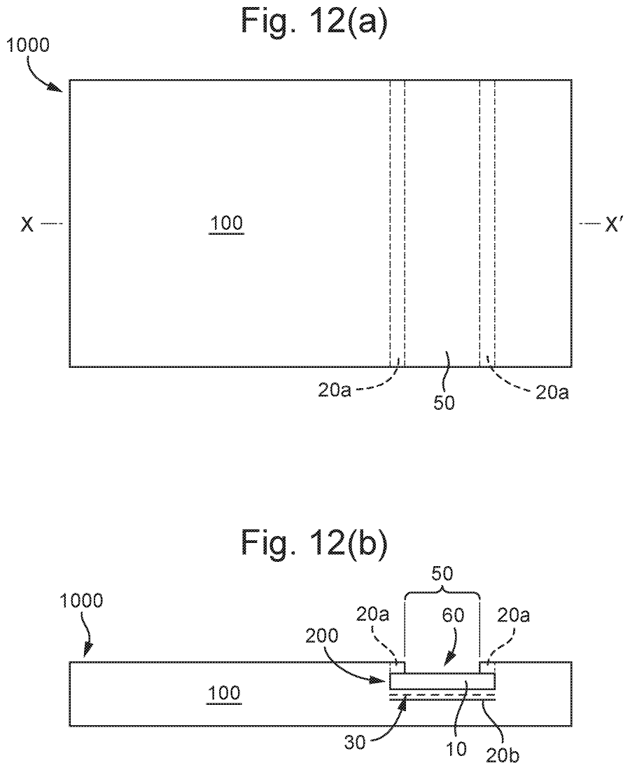

FIGS. 12(a) and 12(b) schematically illustrate a yet further example of a structure that may be provided in S100, again in the form of a paper banknote 1000. In this example, the security article 200 is in the form of a strip that is fully exposed within aperture region 50 through partial thickness aperture 60 that laterally extends across the full height of the banknote. As shown in FIG. 12(b) which is a cross section along line X-X′, the strip comprises a transparent substrate 10 and optical effect layer 30, and is adhered into the paper substrate using adhesive layers 20a and 20b. The adhesive layer 20a that is on a side of the strip 200 that is exposed through the aperture 60 is in the form of elongate strips, or “tramlines” that extend continuously along the lateral edges of the strip. The exposed side of the strip 200 is therefore adhered into the paper substrate only at its lateral edge regions, such that the surface of the strip that is exposed within the aperture region 50 through the aperture 60 comprises the substrate 10. The opposing side of the strip is adhered to the document substrate using adhesive layer 20b that extends substantially continuously over the opposing surface of the substrate 10.

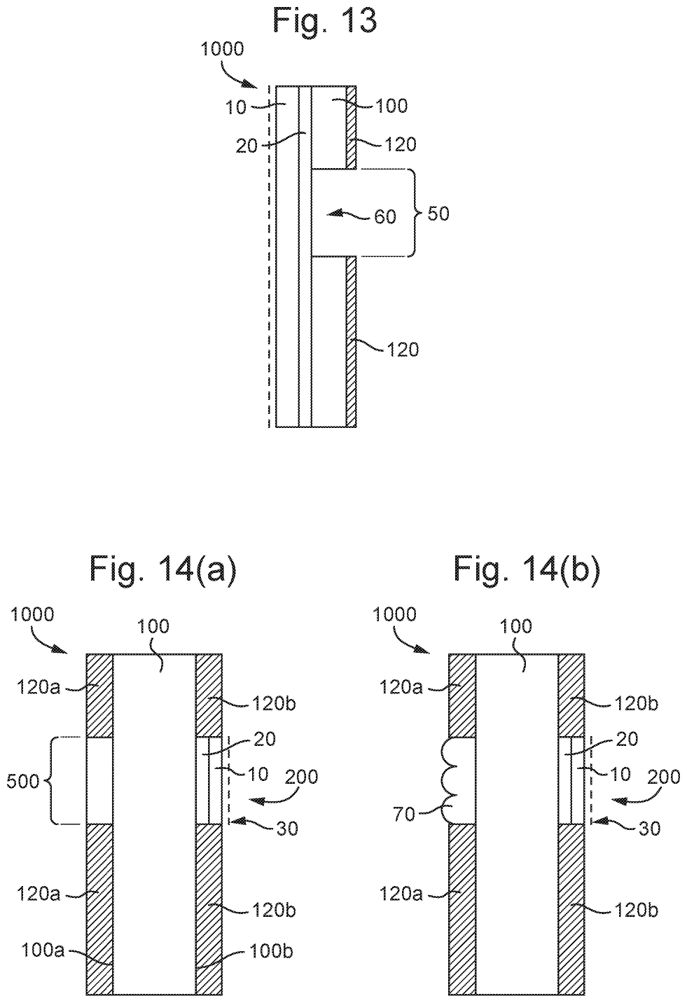

FIG. 13 illustrates a further example similar to the one set out above with reference to FIG. 9. In FIG. 13, the security document substrate is a substantially transparent polymer substrate such as PET or BOPP comprising an aperture region 50 having a full thickness aperture 60. The strip 200 is adhered on to one side of the polymer 100 across the aperture using adhesive layer 20 such that it is exposed within the aperture region 50 through the aperture 60. The array of refractive structures is then applied on the exposed adhesive layer of the strip in the same manner as has been described.

In such examples where the security document substrate comprises a transparent polymer, one or more opacifying layers 120 are typically applied to at least one surface of the polymer substrate so as to clearly define the aperture through which the security article is exposed. The opacifying layers are substantially opaque to light in the visible part of the electromagnetic spectrum.

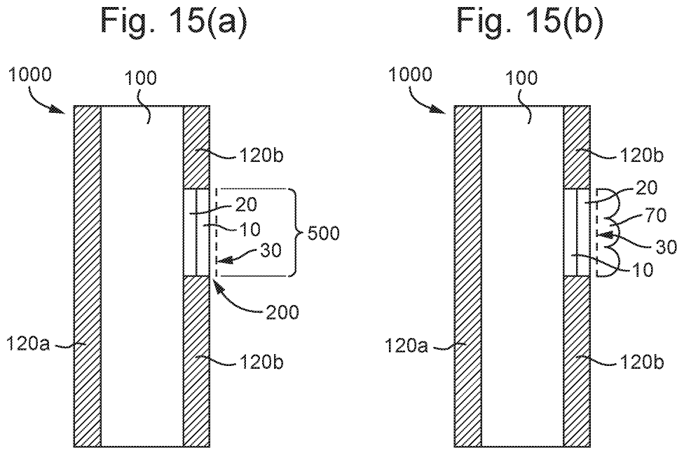

FIGS. 14 and 15 illustrate comparative examples. FIG. 14(a) illustrates a cross section of a security document 1000, again in the form of a banknote, which may be provided before application of refractive structures. Here, the security document substrate 100 comprises a transparent BOPP substrate. A window region 500 is defined by application of opacifying layers 120a and 120b on front 100a and reverse 100b sides of the banknote substrate 100 respectively. Here the window region is a “full thickness” window region in that the security article 200 is visible from both sides of the banknote.

The security article 200 is in the form of a laminate foil and is adhered to the reverse surface 100b of banknote substrate 100 within window region 500. The security article 200 comprises a substrate 10, optical effect layer 30 and adhesive layer 20 used to adhere the article 200 to the banknote substrate 100. The optical effect layer 30 in these comparative examples is in the form of a microimage array, and is visible within the window region 500 from both sides of the banknote.

FIG. 14(b) schematically illustrates the application of an array of refractive structures 70 on part of the security document substrate 100 that is exposed within window region 500 on the front side of the banknote. Here, the array of refractive structures is in the form of an array of microlenses that cooperate with the microimage array to exhibit a first optical effect. The array 70 may be applied using any of the techniques that have been discussed above.

FIGS. 15(a) and 15(b) illustrate a variation in which the opacifying layers 120a and 120b are arranged such that the security article 200 is visible within window region 500 on only one side of the banknote, as opacifying layer 120a is provided to as to laterally extend continuously across window region 500. In this example, as shown in FIG. 15(b), the array of microlenses 70 is applied to the security article itself that is exposed within the window region.

In the comparative examples of FIGS. 14 and 15, the security article 200 is in the form of a laminate foil. In other comparative examples, the security article may be in the form of a transfer or release foil comprising an adhesive layer and optical effect layer.

Referring back to FIG. 1, after the refractive structures have been applied in step S200, the method may optionally continue to steps S300, S400 and S500 in order to form the finished security document.

At step S300, a graphics layer is applied, typically by way of security printing techniques. For example, the graphics layer may be printed by any conventional printing technique, or combination of techniques, such as intaglio printing, lithographic printing, offset printing, flexographic printing, gravure printing and the like. The graphics layer typically comprises high resolution patterns such as fine line patterns and guilloches, portraits, and other indicia. In the examples where the security document substrate is a paper substrate, one or more graphics layers may be printed directly onto the paper substrate. Where the security document substrate comprises a transparent polymer substrate, such a graphics layer is applied to one or more opacifying layers 120 that are provided to at least one of the surfaces of the polymer substrate.

In step S400, which is also optional, any additional security devices or articles such as threads, strips, patches etc., are applied to the substrate. Any conventional techniques for applying such components can be utilised, including bonding by adhesives, lamination, hot stamping, transfer methods and the like. The security devices could be of any known type, such as holograms, kinegrams and other diffractive elements, iridescent or colour-shift material, etc. Steps S300 and S400 could take place in either order and/or as a series of sub-steps which could be intermingled with one another. Finally, the processed sheet material is cut into individual security documents in step S500.

In the examples that have been described above, the security document has been in the form of a banknote. However, as will be appreciated by the skilled person, the security document may take other forms such as cheques, passports, identity cards, certificates of authenticity, fiscal stamps, visas or other documents for securing value or personal identity.

1-61. (canceled)

62. A method of forming a security document, the method comprising:
(a) providing a security document substrate having a security article integrated within or attached thereto, the security article being exposed within an aperture region in the security document substrate,
the security article comprising a first optical effect layer that is visible within the aperture region, and;
(b) applying, in said aperture region within which the security article is exposed, an array of substantially transparent refractive structures on the exposed security article, wherein the array of refractive structures cooperates with the first optical effect layer to exhibit a first optically variable effect

63. The method of claim 62, wherein the security article comprises
a security article substrate, and
a first adhesive layer forming a first outer layer of the security article, wherein at least a part of said first adhesive layer is in contact with the security document substrate.

64. The method of claim 63, wherein at least a part of the first adhesive layer is exposed within said aperture region, and wherein step (b) comprises applying said array of substantially transparent refractive structures on the exposed part of the first adhesive layer of the security article.

65. The method of claim 63, wherein the first adhesive layer is present substantially only in region(s) of the security article which are not exposed within the aperture region.

66. The method of claim 62, wherein the aperture region comprises an aperture in the security document substrate, and wherein the security article is exposed through said aperture, and step (b) comprises applying said array of refractive structures on the exposed security article through said aperture.

67. The method of claim 62, wherein the array of refractive structures extends outside the aperture region.

68. The method of any of claim 62, wherein step (b) comprises:
(i) applying a transparent curable material on the exposed security article or to a casting tool carrying a surface relief corresponding to the refractive structures, at least over an area corresponding to the exposed security article;
(ii) forming the transparent curable material with the casting tool, and;
(iii) curing the transparent curable material so as to retain the surface relief.

69. The method of claim 68, wherein in step (b)(i) the transparent curable material is applied on the exposed security article and on a region of security document substrate outside the aperture region.

70. The method of claim 62, wherein step (b) comprises:
(i) applying a transparent curable material to a refractive structure support layer or to a casting tool carrying a surface relief corresponding to the refractive structures, at least over an area corresponding to the exposed security article;
(ii) forming the transparent curable material with the casting tool,
(iii) curing the transparent curable material so as to retain the surface relief, and;
either applying the refractive structure support layer to the exposed security article, or applying the retained surface relief to the exposed security article and removing the refractive structure support layer.

71. The method of claim 62, wherein the array of substantially transparent refractive structures is applied in direct contact with the exposed security article within the aperture region.

72. The method of any claim 62, further comprising the step of applying, on the exposed security article substrate in said aperture region, a substantially transparent pedestal layer, and wherein the array of substantially transparent refractive structures is applied on said pedestal layer.

73. A security document comprising;
a security document substrate having a security article integrated within or attached thereto, the security article being visible within an aperture region in the security document substrate, wherein the security article comprises;
an optical effect layer that is visible within the aperture region, and
a first adhesive layer forming a first outer layer of the security article, wherein the first adhesive layer is in contact with the security document substrate such that the security article is adhered to the security document substrate, and a part of the first adhesive layer laterally extends across the aperture region, wherein the security document further comprises;
an array of substantially transparent refractive structures on the part of the first adhesive layer that laterally extends across the aperture region, wherein said array of refractive structures cooperates with the optical effect layer to exhibit an optically variable effect.

74. The security document of claim 73, wherein the array of refractive structures is in direct contact with the first adhesive layer.

75. The security document of claim 73, further comprising a support layer positioned between the array of refractive structures and the first adhesive layer.

76. The security document of claim 73, wherein the security article comprises a security article substrate, and the first adhesive layer extends substantially continuously across a first surface of the security article substrate.

77. The security document of claim 73, wherein the array of refractive structures extends outside the aperture region such that a region of the array is on the security document substrate.

78. The security document of any claim 77, wherein a region of the security document substrate outside the aperture region that is covered by the array of refractive structures comprises a second optical effect layer that cooperates with the corresponding region of the array to exhibit a second optically variable effect.

79. The method of claim 62, wherein the first optical effect layer comprises a colour shifting layer or pattern of elements.

80. The security document of claim 73, wherein the first optical effect layer comprises a colour shifting layer or a pattern of elements.

81. The method of claim 62, wherein the array of refractive structures comprises an array of focusing elements, or wherein the array of refractive structures comprises an array of microprisms.

82. The security document of claim 73, wherein the array of refractive structures comprises an array of focusing elements, or wherein the array of refractive structures comprises an array of microprisms.

83. The method of claim 62, wherein the security document substrate comprises a fibrous substrate.

84. The method of claim 73, wherein the security document substrate comprises a fibrous substrate.
